(19) United States
(12) Patent Application Publication
(10) Pub. No.: US 2026/0210994 A1
(43) Pub. Date: Jul. 23, 2026

(54) Apparatus and Method for Measuring Wind Direction and Speed

(71) Applicant: Asiatelco Technologies Inc., Irvine, CA (US)

(72) Inventors: Kang Jianwei, Shanghai (CN); Ding Junming, Shanghai (CN); He Lin, Shanghai (CN)

(73) Assignee: Asiatelco Technologies Inc., Irvine, CA (US)

(21) Appl. No.: 19/066,519

(22) Filed: Feb. 28, 2025

(30) Foreign Application Priority Data
Jan. 17, 2025 (CN) 202510075925.0

(51) Int. Cl. G01P 5/02

(52) U.S. Cl. CPC G01P 5/02

(57) ABSTRACT

A wind direction and speed measuring apparatus includes a cover portion, a swing pin attached to the cover portion, a base disposed below the swing pin, a wind resistance ball attached to the swing pin and suspended above the base, and a magnet disposed at the bottom of the wind resistance ball. A magnetic sensor on the base detects a current magnetic flux of the magnet. A controller obtains the current magnetic flux of the magnet and determines a current wind speed and current wind direction based on a difference between the current magnetic flux of the magnet and an initial magnetic flux of the magnet in a windless state. The apparatus is simple and low-cost, and can accurately measure wind direction and wind speed.

### FIELD

The present invention relates to the technical field of wind direction and wind speed measurement. More specifically, the invention relates to a wind direction and wind speed measurement apparatus and method.

### BACKGROUND

As a natural phenomenon, wind is one of the important factors affecting climate, and it contains huge energy. Since wind speed directly affects many aspects of human life and social production, people have always attached great importance to wind monitoring. Wind speed measurement is widely used in meteorology, civil aviation, highways, bridges, new energy and other industries, and has broad prospects.

In related technologies, two anemometers are mainly used: the traditional mechanical wind cup (3-Cup) type and the ultrasonic anemometer. Mechanical wind cup anemometers rely on mechanical rotation to measure wind speed, and there is mechanical rotation noise. Although ultrasonic anemometers have no mechanical rotating parts, ultrasonic devices are expensive and have low popularity.

### SUMMARY

The present invention is proposed to address the above problems. According to an embodiment of the present invention, a wind direction and wind speed measuring device is provided that includes a base, a swing pin, a wind resistance ball, a magnetic sensor, and a controller. The wind resistance ball is suspended above the base through the swing pin. The bottom of the wind resistance ball includes a magnet. The magnetic sensor is installed on the base, below the magnet along the height direction. The magnetic sensor detects the magnetic flux of the magnet. The controller, which is electrically connected to the magnetic sensor, senses the current magnetic flux of the magnet and the initial magnetic flux of the magnet in a windless state. The difference between the initial and the current magnetic flux of the magnet is used to determine the current wind speed and direction.

Some embodiments include an electronic compass, which may be installed on the base. The controller is connected to the electronic compass to obtain the geomagnetic azimuth angle detected by the electronic compass.

Some embodiments include a fixed cover disposed above the base. The wind resistance ball is located between the fixed cover and the base, with one end of the swing pin attached to the fixed cover and the other end attached to the wind resistance ball.

Some embodiments include a protective net between the fixed cover and the base, with the protective net disposed around the outside of the wind resistance ball.

In some embodiments, the current wind speed and wind direction are determined based on the difference between the current magnetic flux of the magnet and the initial magnetic flux of the magnet in the absence of wind. In these embodiments, the magnetic flux includes a first magnetic flux along the x-axis direction of the magnetic sensor, a second magnetic flux along the y-axis direction of the magnetic sensor, and a third magnetic flux in the z-axis direction of the magnetic sensor. The current magnetic flux includes the current first magnetic flux, the current second magnetic flux, and the current third magnetic flux. The initial magnetic flux includes the initial first magnetic flux, the initial second magnetic flux, and the initial third magnetic flux. The current wind speed and direction are determined based on the difference between the current magnetic fluxes (first, second and third) of the magnet and the initial magnetic fluxes (first, second and third) of the magnet in a windless state.

In some embodiments, the magnetic wind direction is determined according to the first magnetic flux difference and the second magnetic flux difference. The first magnetic flux difference is the difference between the current first magnetic flux and the initial first magnetic flux. The second magnetic flux difference is the difference between the current second magnetic flux and the initial second magnetic flux. The current wind direction is determined based on the magnetic wind direction. For example, the device may include an electronic compass that detects the geomagnetic azimuth, and the current wind direction is determined based at least in part on the magnetic wind direction.

In some embodiments, the current wind direction is determined based at least in part on the magnetic wind direction and the geomagnetic azimuth angle.

In some embodiments, the actual geomagnetic azimuth angle is determined based on the difference between the geomagnetic azimuth angle and the geomagnetic declination angle. In some embodiments, the actual geomagnetic azimuth angle is determined based on the magnetic wind direction and the deviation angle between the electronic compass and the magnetic sensor.

In some embodiments, the deviation angle is the angle between the device coordinate system corresponding to the electronic compass and the device coordinate system corresponding to the magnetic sensor.

In some embodiments, determining the magnetic wind direction based on the first magnetic flux difference and the second magnetic flux difference includes:
when the first magnetic flux difference is greater than zero and the second magnetic flux difference is equal to zero, the magnetic wind direction is determined to be 90°;
when the first magnetic flux difference is less than zero and the second magnetic flux difference is equal to zero, the magnetic wind direction is determined to be 270°; and
when the second magnetic flux difference is not equal to zero, the magnetic wind direction is determined based on the current wind angle, which is calculated as the arctangent of the ratio of the first magnetic flux difference to the second magnetic flux difference.

In some embodiments, the current wind speed and wind direction are determined based at least in part on the difference between the current magnetic flux of the magnet and the magnetic flux of the magnet in a windless state.

In some embodiments, the magnetic flux includes a first magnetic flux along the x-axis direction of the magnetic sensor, a second magnetic flux along the y-axis direction of the magnetic sensor, and a third magnetic flux along the z-axis direction of the magnetic sensor in the axial direction. The current magnetic flux of the magnet includes the current first magnetic flux, the current second magnetic flux and the current third magnetic flux. The magnetic flux of the magnet in the windless state includes the initial first magnetic flux, the initial second magnetic flux and the initial third magnetic flux. The difference between the magnetic fluxes of the magnet in different states determines the current wind speed, wherein the current magnetic flux intensity is determined based on the difference between the current first magnetic flux and the initial first magnetic flux, and the difference between the current second magnetic flux and the initial second magnetic flux.

In some embodiments, before determining the current magnetic flux intensity based on the difference between the current first magnetic flux and the initial first magnetic flux, and the difference between the current second magnetic flux and the initial second magnetic flux, preferred embodiments also include determining whether the current third magnetic flux exceeds a magnetic flux threshold. If the current third magnetic flux exceeds the magnetic flux threshold, the current wind speed is determined also based on the current third magnetic flux.

In some embodiments, when the third magnetic flux does not exceed the magnetic flux threshold, the step of determining the current magnetic flux intensity is based on the difference between the current first magnetic flux and the initial first magnetic flux, and the difference between the current second magnetic flux and the initial second magnetic flux. In some embodiments, obtaining the current magnetic flux of the magnet includes:
using the magnetic sensor to repeatedly detect the magnetic flux of the magnet periodically within a preset time period to obtain multiple sets of magnetic flux data; and
calculating the average value of the multiple sets of magnetic flux data to obtain the current magnetic flux.

Preferred embodiments described herein use a magnetic sensor to detect the change in the magnetic flux of the magnet when the wind resistance ball is displaced to determine the wind direction and wind speed. Compared with the mechanical wind cup anemometer, which has continuously rotating mechanical parts, these preferred embodiments function based on only a small displacement of the wind resistance ball. These embodiments create no noise, are environmentally friendly, and have an overall structure that is simple, cost less than ultrasonic wind meters, and are easy to be promoted and used in the civilian field. In addition, the preferred embodiments have fewer energy-consuming components (such as controllers and magnetic sensors) during operation, require low energy consumption for operation, and have low usage cost. In short, embodiments of the present invention have a simple structure, low cost, no noise, high test accuracy, and can be used for wind speed measurements in the civilian field.

The above summary is only an overview of the technical solution provided by embodiments of the present invention. The detailed description that follows provides a clearer understanding of the technical structure and implementation of the preferred embodiments. In order to achieve the above and other purposes of the present invention, the features and advantages can be more clearly understood from the following detailed description of specific embodiments of the present invention.

### BRIEF DESCRIPTION OF THE DRAWINGS

Other embodiments of the invention will become apparent by reference to the detailed description in conjunction with the figures, wherein elements are not to scale so as to more clearly show the details, wherein like reference numbers indicate like elements throughout the several views, and wherein:

FIG. 1 depicts a wind direction and wind speed measuring device according to an embodiment of the invention;

FIG. 2 depicts a wind direction and wind speed measurement principle according to an embodiment of the invention;

FIG. 3 depicts a coordinate system of a wind direction and wind speed measurement system according to an embodiment of the invention;

FIG. 4 depicts a schematic block diagram of a wind direction and wind speed measurement system according to an embodiment of the invention;

FIG. 5 depicts a functional block diagram of a wind direction and wind speed measurement system according to an embodiment of the invention;

FIG. 6 depicts a schematic diagram of a wind direction and wind speed measurement method according to an embodiment of the invention;

FIG. 7 depicts a schematic diagram of the movement of a wind resistance ball under the action of wind according to an embodiment of the invention; and

FIG. 8 depicts a graph of magnetic flux versus angle according to an embodiment of the invention.

### DETAILED DESCRIPTION

In order to make the objectives, technical solutions and advantages of the present invention more apparent, exemplary embodiments will be described in detail below with reference to the accompanying drawings. Obviously, the described embodiments are only some embodiments of the present invention. It should be understood that the present invention is not limited to the example embodiments described here. Based on the embodiments of the present invention described herein, all other embodiments obtained by those skilled in the art without exerting creative efforts should fall within the protection scope of the present invention.

As mentioned above, in related technologies, two types of anemometers have been mainly used. One is the traditional mechanical wind cup (3-Cup) type, and the other is an ultrasonic anemometer. The mechanical cup anemometer, which relies on mechanical rotation to measure wind speed, creates mechanical rotation noise and environmental pollution. Moreover, the mechanical cup anemometer is a relatively large device having a slow response speed, obvious hysteresis, mechanical wear, and low accuracy of results. Especially when measuring low wind speeds, the measurement results from the mechanical cup anemometer have large errors. Although ultrasonic wind meters do not have mechanical rotating parts, they are constructed from ultrasonic devices that are expensive, and their popularity in the civilian field is low. Moreover, the installation of ultrasonic wind meters will directly affect the accuracy of measurement, so the installation requirements are very strict, the structure is complex, and the anti-interference performance is poor. In view of this, embodiments of the present invention provide a wind direction and wind speed measurement device that has a simple structure, low cost, no noise, and high test accuracy, and can be used for wind speed measurement in the civilian field.

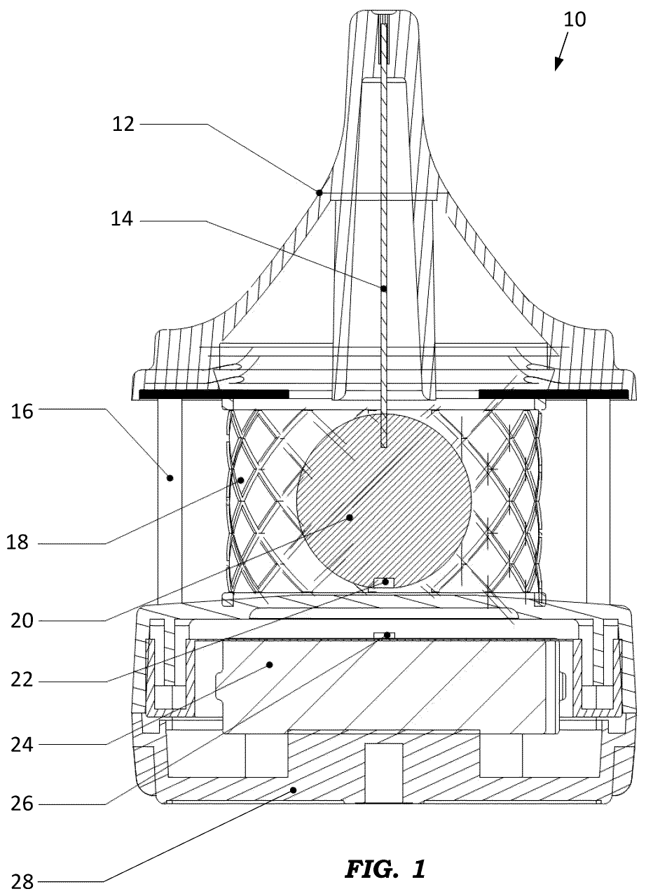

FIGS. 1 and 4 depict a preferred embodiment of a wind direction and wind speed measuring device 10. The device 10 includes a base 28, a swing pin 14, a wind resistance ball 20, a magnet 22, a magnetic sensor 26, and a controller 32. The wind resistance ball 20 is suspended above the base 28 through the swing pin 14. The magnet 22 is disposed at the bottom of the wind resistance ball 20. The magnetic sensor 26 is installed on the base 28, and is located below the magnet 22 along the height direction. The magnetic sensor 26 is used to detect the magnetic flux of the magnet 22 which is provided to the controller 32.

The controller 32 receives the current magnetic flux of the magnet 22 and determines the current wind speed and wind direction based on the difference between the current magnetic flux of magnet 22 and an initial magnetic flux of the magnet 22 in a windless state. In various embodiments, the controller 32 may use any existing or future developed chip with control functions. For example, the controller 32 may comprise an nRF52832 chip provided by Nordic Semiconductor.

In preferred embodiments, the wind resistance ball 20 is constructed from a lightweight material that can generate displacement under the action of wind force. The bottom and top of the wind resistance ball 20 correspond to the lowest point and the highest point, respectively, of the wind resistance ball 20 in a windless state.

In preferred embodiments, the wind resistance ball 20 is suspended above the base 28 by the swing pin 14. The swing pin 14 is arranged vertically, with its top fixed and its bottom end connected to the wind resistance ball 20. The swing pin 14 has a certain degree of flexibility, thereby ensuring that the wind resistance ball 20 can be displaced under the action of wind force. The swing pin 14 can be attached to the base 28 in various ways. For example, the top end of the swing pin 14 can be attached by a bracket. The material, diameter and length of the swing pin 14 can be selected as needed. In a specific embodiment, the swing pin 14 comprises a carbon steel wire having a diameter of 0.8 mm.

In preferred embodiments, the wind resistance of the wind resistance ball 20 can be determined. A wind pressure calculation formula and a swing pin deformation calculation formula under the action of wind pressure may be used to simulate the theoretical data indicating the expected deflection of swing pins and wind resistance balls of different specifications under the action of wind force. Such calculations would be made based on the diameter of the wind resistance ball 20, simulation results, the diameter and length of the swing pin 14, and other parameters.

Optionally, the initial magnetic flux can be predetermined in a windless state before the device 10 leaves the factory, or it can be measured using the magnetic sensor 26 in a windless state after the device 10 is installed in the working environment.

In preferred embodiments, the magnetic sensor 26 is used to detect the magnetic flux of the magnet 22. Specifically, the magnetic sensor 26 detects the magnetic flux of the magnet 22 in each axis (x-axis, y-axis, z-axis) of the coordinate system of the magnetic sensor 26. In various embodiments, the magnetic sensor 26 may comprise any existing or future developed magnetic sensor that can detect the magnetic flux of the magnet 22 in three dimensions. In a preferred embodiment, the magnetic sensor 26 is a model number TLV493D-W2B6 provided by Infineon Technologies AG.

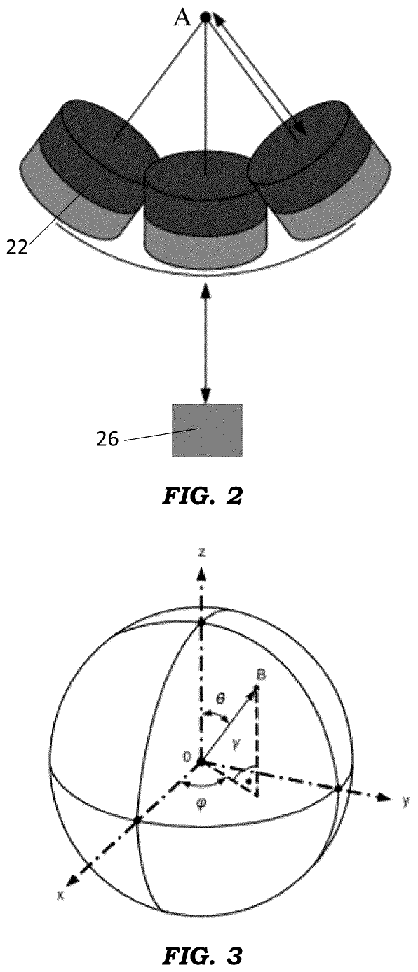

FIGS. 2 and 3 depict schematic diagrams of the magnetic flux measurement principle according to an embodiment of the present invention. As shown in FIG. 2, the suspended magnet 22 moves spherically around the fulcrum point A in close proximity to the magnetic sensor 26. This movement pattern is also referred to herein as a joystick movement pattern. The magnetic sensor 26 detects changes in magnetic flux in the three directions x, y, and z of the coordinate system shown in FIG. 3. This change in flux can be used to calculate the movement direction angle of the magnet 22.

As shown in FIG. 3, taking the detection center point of the magnetic sensor 26 as the origin, a magnetic spherical model can be established. The motion of the magnet 22 can be expressed as spherical motion based on Br, which is the residual magnetic force (the maximum magnetic flux) of the magnet 22. All final motions can be described by the vertical offset angle and the horizontal offset angle, which is the wind direction.

In FIG. 3, B represents the next magnetic point in the spherical magnetic model, and γ represents the radius from this magnetic point to the center point. It is known from the magnetic spherical model that:

$$r = \sqrt{{x}^{2} + {y}^{2} + {z}^{2}}$$

$$θ = arccos \frac{z}{\sqrt{{x}^{2} + {y}^{2} + {z}^{2}}} = arccos \frac{z}{r} = \frac{π}{2} - arctan \frac{z}{\sqrt{{x}^{2} + {y}^{2}}}$$

$$and$$

$$φ = a tan 2 ( y , x ) = \{ \begin{matrix}arctan ( \frac{y}{x} ) , & if x > 0 \\ sgn ( y ) \frac{π}{2} , & if x = 0 \\ arctan ( \frac{y}{x} ) + π , & if x < 0 ⋀ y \geq 0 \\ arctan ( \frac{y}{x} ) - π , & if x < 0 ⋀ y < 0\end{matrix} \} .$$

In the above solution, it should be appreciated that the radius r of the magnetic spherical model is equivalent to Br, the magnetic flux in the x direction is equivalent to Bx, the magnetic flux in the y direction is equivalent to By, and the magnetic flux in the z direction is equivalent to Bz. The magnetic sensor 26 can detect changes in magnetic flux in the three directions x, y, and z. Based on the changes in magnetic flux in the x and y directions, the current wind direction can be calculated. By fitting the changes in magnetic flux in the x and y directions, the current wind speed can be obtained after conversion.

In preferred embodiments, the working principle of the device 10 is that the wind resistance ball 20 is displaced by a certain amount in the wind direction under the action of wind force, which drives the magnet 22 installed at the bottom of the wind resistance ball 20 to move. The magnetic sensor 26 located below the magnet 22 detects the magnetic flux of the magnet 22 after the displacement. The controller 32 determines the current wind speed and wind direction based on the change in the measured magnetic flux of the magnet 22, which is the difference between the initial magnetic flux of the magnet 22 in a windless state and the current magnetic flux of the magnet 22 when the ball 20 is displaced by wind.

In some embodiments, the device 10 also includes an electronic compass 40 installed on the base 28. The controller 32 is connected to the electronic compass 40 to obtain the geomagnetic azimuth angle detected by the electronic compass 40. The electronic compass 40 can be any existing or future developed sensor that can measure the direction of the earth's magnetic field. In a preferred embodiment, the electronic compass 40 is a model number HMC5883L provided by Honeywell.

It will be appreciated that traditional wind meters need to be calibrated with a reference direction during installation in order to determine the correct wind direction. This method is complex to operate, and if the installation position of the device deviates during actual use, it needs to be recalibrated, which is inefficient. In embodiments of the present invention, the installation azimuth of the electronic compass 40 (that is, the geomagnetic azimuth) is used. The geomagnetic azimuth can correct the wind direction calculated using changes in magnetic flux, thereby ensuring that the obtained results are more accurate.

The installation position of the electronic compass 40 can be selected according to the requirements of the installation site. In some embodiments, the x and y axes of the device coordinate system of the electronic compass 40 can be aligned with the x and y axes of the device coordinate system of the magnetic sensor 26. Of course, the directions of the x and y axes of the electronic compass 40 and the x and y axes of the magnetic sensor 26 may also be inconsistent. For example, the included angle may be a preset included angle, which will not be described further.

The technical solution described herein can accurately sense the geomagnetic azimuth angle of the device 10 by setting up the electronic compass 40. Compared with existing wind meters, the device 10 does not need to calibrate the reference direction, is easy to install and use, and can detect wind direction even if the installation position is offset. The geomagnetic azimuth automatically corrects the wind direction results, which helps to further improve the accuracy of the results.

In the embodiment shown in FIG. 1, the device 10 also includes a fixed cover 12, which is attached above the base 28. The wind resistance ball 20 is located between the fixed cover 12 and the base 28, with one end of the swing pin 14 attached to the fixed cover 12, the other end attached to the wind resistance ball 20.

In the embodiment shown in FIG. 1, a support column 16 is disposed between the fixed cover 12 and the base 28 to provide support for the fixed cover 12. In some embodiments, the fixed cover 12 may not be connected to the base 28. For example, a separate support frame can be provided to dispose the fixed cover 12 above the base 28.

The configuration of FIG. 1 not only simplifies the installation and positioning process of the swing pin 14 by providing a fixed protective cover 12, but also provides effective protection for the swing pin 14 and wind resistance ball 20 below. The protective cover 12 can prevent rain and other external factors from directly contacting the swing pin 14 and wind resistance ball 20, thereby reducing the occurrence of corrosion and significantly extending the service life of the device 10.

In some embodiments, a protective net 18 is disposed between the fixed cover 12 and the base 28, and encircles the wind resistance ball 20. In this example, the mesh size of the protective net 18 can be selected as needed to prevent small wind-born objects from impacting the wind resistance ball 20 as much as possible. Thus, by surrounding the wind resistance ball 20, the protective net 18 prevents the wind resistance ball 20 from being damaged by animals or other foreign objects in the wild, which helps to further increase the service life of the device 10.

In some embodiments, the device 10 also includes a communication module 30 that is connected to, or is part of, the controller 32. The communication module 30 is used to transmit the determined wind direction and wind speed values to a user terminal. Preferably, the communication module 30 comprises but is not limited to a Bluetooth chip, a Wi-Fi module, a 4G/5G communication module, etc. In a preferred embodiment, the communication module 30 is a Bluetooth chip, and a user can wirelessly read the wind direction and wind speed values using a mobile device that is in communication with the communication module 30 via a Bluetooth signal.

In preferred embodiments, the device 10 includes a power supply 24 connected to the controller 32, the magnetic sensor 26, and the electronic compass 40. The power supply 24 may be a wired power source or a battery. In a specific embodiment, the power supply 24 is a dry cell battery. It should be appreciated that since the device 10 has few energy-consuming components and requires low energy consumption, it can be powered by dry batteries for a long time.

In some embodiments, the controller 32 also controls the power supply 24 to periodically power on the magnetic sensor 26 to control the magnetic sensor 26 to work periodically. This power-on period can be selected as needed. For example, it can be daily. In this case, the device 10 determines wind direction and speed once a day.

Alternatively, the controller 32 can control the power supply 24 to power on the electronic compass 40 while controlling the power supply 24 to power on the magnetic sensor 26. In this embodiment, the electronic compass 40 can be turned on at the same time every time the magnetic sensor 26 is used for testing. In this way, the magnetic flux obtained by the magnetic sensor 26 basically corresponds in time to the geomagnetic azimuth obtained by the electronic compass 40, which helps to improve the accuracy of the final determined wind direction.

In some embodiments, the device 10 further includes a key switch 36 connected to the controller. The key switch 36 can be disposed on the base 28. In other embodiments, the device 10 may further include an indicator light 38 connected to the controller 32 that is used to indicate the working status of the device 10. The indicator light 38 can be disposed on the base 28. For example, the indicator light 38 can illuminate when the magnetic sensor 26 is operating.

As shown in FIG. 4, the controller 32 may comprise a Bluetooth low energy processor that includes a communication module 30 connected to a Bluetooth antenna 34. The controller 32 is also connected to the magnetic sensor 26 and the electronic compass sensor 40. The magnetic sensor 26 and electronic compass sensor 40 are each preferably connected to the power supply 24 through a low dropout (LDO) circuit. The power supply 24, which may comprise three dry batteries, and the indicator light 38 and the key switch 36 are all connected to the controller 32. In this embodiment, the controller 32 is connected to two LDOs. The controller 32 can control the LDOs to power on and off the magnetic sensor 26 and the electronic compass 40. In this embodiment, the controller 32 automatically wakes up periodically, powers on the magnetic sensor 26, continuously samples the magnetic flux in the x, y, and z directions output by the magnetic sensor 26 at a rate of 5 ms-20 ms for a period of 3 s-20 s, processes and averages all the sampled values, and outputs the magnetic direction of the wind direction and the magnitude of the wind force. For the magnetic direction of the wind direction, the actual wind direction information from the east, west, south, and north of the earth is output with reference to the geomagnetic azimuth angle through the readings of the electronic compass 40. The final wind direction and wind force information is preferably transmitted through a Bluetooth broadcast or Bluetooth connection.

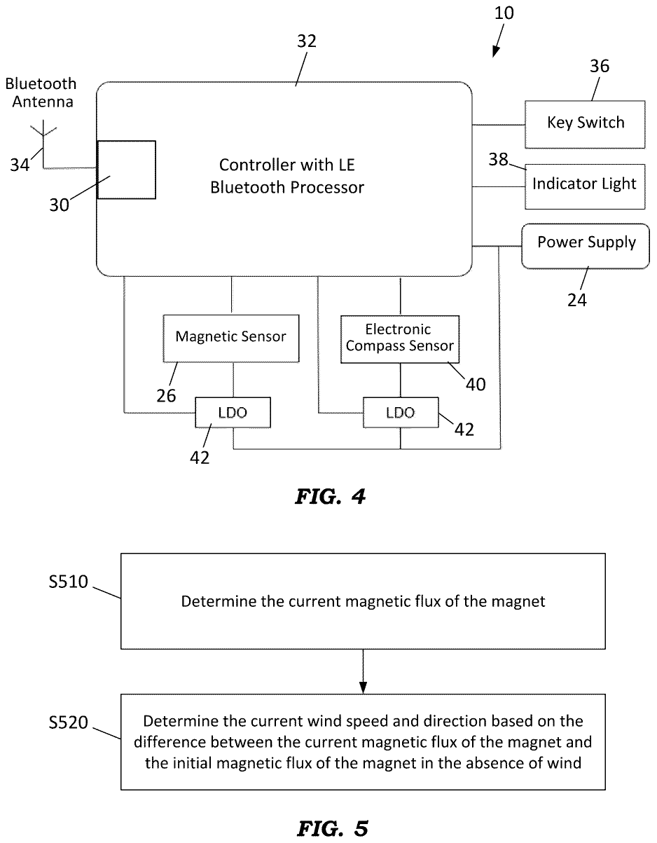

According to another aspect of some embodiments, a method is provided for measuring wind direction and speed, which method may be performed by the device 10 in any of the embodiments described herein. FIG. 5 shows a flow chart of a wind direction and wind speed measurement method according to a preferred embodiment. As shown in FIG. 5, the method may include the following steps S510 and S520. In step S510, the current magnetic flux of the magnet 22 is obtained. Alternatively, the current magnetic flux of the magnet 22 may be the magnetic flux detected using the magnetic sensor 24 at the current moment. Alternatively, the current magnetic flux of the magnet 22 may also be determined based on the average value of the magnetic flux detected repeatedly by the magnetic sensor 24.

In step S520, after obtaining the current magnetic flux of the magnet 22, the current wind speed and wind direction are determined based at least in part on a difference between the current magnetic flux of the magnet 22 and the initial magnetic flux of the magnet 22 in a windless state. Thus, the method determines the current wind speed and direction by utilizing the change in magnetic flux of the magnet 22 when the wind resistance ball 20 swings with the wind. The operation is simple, the results are highly accurate, and it can be applied to wind speed measurement devices having wind resistance balls of different sizes.

In a preferred embodiment of the method, the magnetic flux includes a first magnetic flux along the x-axis direction of the magnetic sensor 26, a second magnetic flux along the y-axis direction of the magnetic sensor 26, and a third magnetic flux along the z-axis direction of the magnetic sensor 26. The current magnetic flux includes the current first magnetic flux, the current second magnetic flux, and the current third magnetic flux. The initial magnetic flux includes the initial first magnetic flux, the initial second magnetic flux, and the initial third magnetic flux.

In step S520, the current wind speed and wind direction are determined based on the difference between the current magnetic flux of the magnet and the initial magnetic flux of the magnet in a windless state, which includes determining the magnetic wind direction based on the first magnetic flux difference and the second magnetic flux difference. The first magnetic flux difference is the difference between the current first magnetic flux and the initial first magnetic flux, and the second magnetic flux difference is the difference between the current second magnetic flux and the initial second magnetic flux. The current wind direction is determined based on the magnetic wind direction.

As mentioned above, the current wind direction can be calculated through the changes in magnetic flux in the x and y directions. In this example, the first magnetic flux difference and the second magnetic flux difference are the magnetic flux changes in the x and y directions. After obtaining the first magnetic flux difference value and the second magnetic flux difference value, the magnetic wind direction can be determined based on the magnetic flux changes in these two directions.

In some embodiments, after obtaining the magnetic wind direction, the magnetic wind direction can be directly used as the current wind direction. In other embodiments, the current wind direction can also be determined in combination with the magnetic wind direction and the geomagnetic azimuth angle. In some embodiments, the magnetic wind direction can be determined more accurately through the changes in magnetic flux in the x and y directions, which helps to provide a more accurate basis for determining the current wind direction. In a preferred embodiment, the device includes an electronic compass, and the method further includes obtaining the geomagnetic azimuth angle detected by the electronic compass. The step of determining the current wind direction based on the magnetic wind direction includes determining the current wind direction based on the magnetic wind direction and the geomagnetic azimuth angle.

In some embodiments, the electronic compass 40 is calibrated before it is used to obtain the geomagnetic azimuth. In one embodiment, the electronic compass 40 can be rotated horizontally at a constant speed to collect x-axis data and γ-axis data of the electronic compass. Then, the mean of the maximum and minimum values of the x-axis data and γ-axis data are calculated to obtain the error values of the x-axis data and γ-axis data respectively. This may be expressed as:

$$Xoffset = ( {X}_{max} + {X}_{min} ) / 2$$

$$Yoffset = ( {Y}_{max} + {Y}_{min} ) / 2$$

in which Xoffset is the x-axis data error value of the electronic compass 40, Yoffset is the y-axis data error value of the electronic compass 40, Xₘₐₓ is the maximum X value, Xₘᵢₙ is the minimum X value, Yₘₐₓ is the maximum Y value, and Yₘᵢₙ is the minimum Y value.

After obtaining the error values of the x-axis data and γ-axis data from the electronic compass 40, the actual geomagnetic x-axis and γ-axis data can be obtained based on the currently detected x-axis data and γ-axis data (i.e., X1 and Y1 in the following formula), and the geomagnetic azimuth angle is determined based on the actual geomagnetic x and y values. Accordingly,

$$X = X 1 - Xoffset ,$$

$$Y = Y 1 - Yoffset , and$$

$$geomagnetic azimuth = arctan ( Y / X ) .$$

The above technical solution can use the geomagnetic azimuth angle to correct the magnetic wind direction, thereby improving the accuracy of the final determined current wind direction.

For example, determining the current wind direction based on the magnetic wind direction and the geomagnetic azimuth angle includes:
determining the actual geomagnetic azimuth angle based on the difference between the geomagnetic azimuth angle and the geomagnetic declination angle; and
determining the actual geomagnetic azimuth angle based on the magnetic wind direction, the actual geomagnetic azimuth angle, and an electronic compass.

The deviation angle from the magnetic sensor 26 determines the current wind direction, where the deviation angle is the angle between the device coordinate system corresponding to the electronic compass 40 and the device coordinate system corresponding to the magnetic sensor 26. Specifically, the angle between the x-axis in the device coordinate system corresponding to the electronic compass 40 and the x-axis in the device coordinate system corresponding to the magnetic sensor 26 can be used as the deviation angle. It will be appreciated that different geographic regions have certain geomagnetic declinations. In view of this, in order to improve the accuracy of the determined geomagnetic azimuth angle, the solution in this example first uses the geomagnetic declination to correct the measured geomagnetic azimuth angle to obtain the actual geomagnetic azimuth angle. This helps to improve the accuracy of the final determined wind direction.

It will also be appreciated that differences in placement between the magnetic sensor 26 and the electronic compass 40 may affect the results. Therefore, when determining the current wind direction, it should be based on the magnetic wind direction, the actual geomagnetic azimuth angle, and the deviation angle between the electronic compass 40 and the magnetic sensor 26. This helps to further improve the accuracy of the determined current wind direction.

In one embodiment, the x and y axes of the magnetic sensor 26 are in the same direction as the x and y axes of the electronic compass 40, in which case the deviation angle is zero. In this embodiment, the current wind direction is determined based on the magnetic wind direction, the actual geomagnetic azimuth angle, and the deviation angle between the electronic compass 40 and the magnetic sensor 26, including calculating the difference between the magnetic wind direction and the actual geomagnetic azimuth angle to obtain the current wind direction. For example, if the magnetic wind direction is 45° and the actual geomagnetic azimuth angle is 0°, then the current wind direction is 45°. If the magnetic wind direction is 55° and the actual geomagnetic azimuth angle is 10°, then the current wind direction is 45°.

In another embodiment, the x-axis and γ-axis directions of the magnetic sensor 26 are inconsistent with the x-axis and γ-axis directions of the electronic compass 40, and the deviation angle between the x-axis of the magnetic sensor and the x-axis of the electronic compass is a preset angle. In this case, the current wind direction is determined based on the magnetic wind direction, the actual geomagnetic azimuth angle, and the deviation angle between the electronic compass 40 and the magnetic sensor 26, including calculating the difference between the magnetic wind direction and the actual geomagnetic azimuth angle. When the direction of the preset angle is positive, the difference is added to the preset angle to get the current wind direction. When the direction of the preset angle is negative, the difference is subtracted from the preset angle to get the current wind direction.

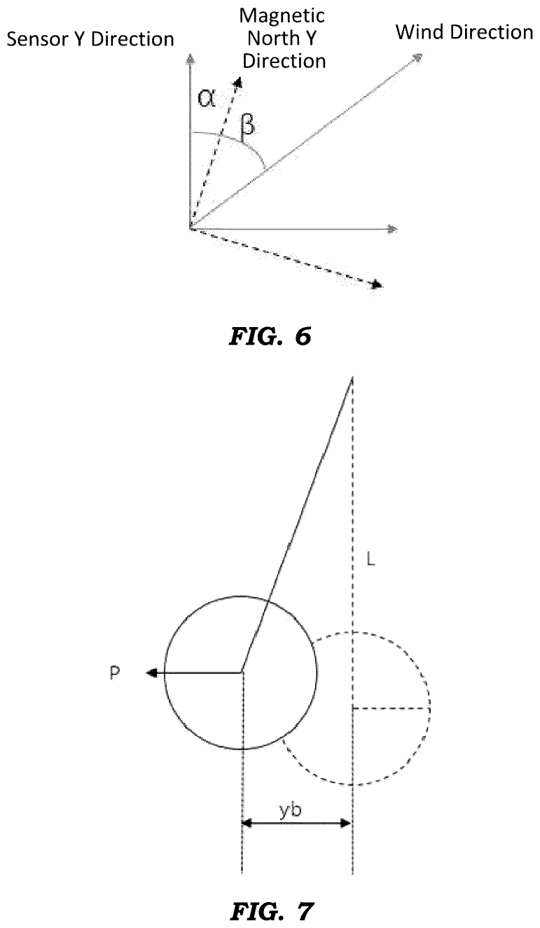

FIG. 6 depicts an exemplary schematic diagram of wind direction of a specific embodiment. As shown in FIG. 6, if the Y direction of the sensor 40 (i.e., the Y direction of the magnetic sensor 26) is defined to be 0 degrees, the calculated wind direction relative to the magnetic sensor 26 is β degrees between the geomagnetic Y direction (i.e., the Y direction of the electronic compass 40) and the Y direction of the magnetic sensor 26. There is an angle difference of α, and the actual wind direction is β-α. In the above technical solution, the current wind direction can be determined more accurately by integrating the magnetic wind direction, the actual geomagnetic azimuth angle, and the deviation angle between the electronic compass 40 and the magnetic sensor 26. The results of this calculation can provide more accurate basis for meteorological monitoring and other fields.

In some embodiments, determining the magnetic wind direction according to the first magnetic flux difference and the second magnetic flux difference includes:
determining the magnetic wind direction to be 90° when the first magnetic flux difference is greater than zero and the second magnetic flux difference is equal to zero;
determining the magnetic wind direction is to be 270° when the first magnetic flux difference is less than zero and the second magnetic flux difference is equal to zero; and
determining the magnetic wind direction based on the current wind angle when the second magnetic flux difference is not zero, wherein the current wind angle is the arctangent of the ratio of the first magnetic flux difference and the second magnetic flux difference.

In some embodiments, the current first magnetic flux is X1, the current second magnetic flux is Y1, the initial first magnetic flux is X0, and the initial second magnetic flux is Y0, and:
if Y1−Y0=0 and X1−X0>0, then the magnetic wind direction angle=90;
if Y1−Y0=0 and X<0, then the magnetic wind direction angle=270;
if X1−X0>=0 and Y1−Y0>0, then the magnetic wind direction angle=atan(Alpha)*180/π;
if X1−X0>=0 and Y1−Y0<0, then the magnetic wind direction angle=180−atan (Alpha)*180/π;
if X1−X0<0 and Y1−Y0>0, then the magnetic wind direction angle=360−atan (Alpha)*180/π; and
if X1−X0<0 and Y1−Y0<0, then the magnetic wind direction angle=180+atan(Alpha)*180/π,
where the current wind angle Alpha=atan(|X1−X0|/|Y1−Y0|).

In some embodiments, determining the magnetic wind direction according to the first magnetic flux difference and the second magnetic flux difference further includes determining that there is currently no wind when the first magnetic flux difference and the second magnetic flux difference are both equal to zero. That is, if X1−X0=0 and Y1−Y0=0, the magnetic wind direction cannot be determined at this time, as there may be no wind at present, so that N/A (not available) may be the output.

The technical solutions described herein can ensure the accuracy of the determined current wind direction under different circumstances by classifying the first magnetic flux difference and the second magnetic flux difference. For example, determining the current wind speed and wind direction is based on the difference between the current magnetic flux of the magnet 22 and the magnetic flux of the magnet 22 in the windless state provides a more accurate measure of the current wind.

In some embodiments, the magnetic flux includes a first magnetic flux along the x-axis direction of the magnetic sensor, a second magnetic flux along the y-axis direction of the magnetic sensor, and a third magnetic flux along the z-axis direction of the magnetic sensor, which is in the axial direction. The current magnetic flux of the magnet includes the current first magnetic flux, the current second magnetic flux, and the current third magnetic flux. In the windless state, the magnetic flux of the magnet includes the initial first magnetic flux, the initial second magnetic flux, and the initial third magnetic flux. The current wind speed is preferably determined based on the difference between the current magnetic fluxes of the magnet and the magnetic fluxes of the magnet in a windless state. This includes determining the current magnetic flux intensity based on the difference between the current first magnetic flux and the initial first magnetic flux, and the difference between the current second magnetic flux and the initial second magnetic flux.

In some embodiments, determining the current magnetic flux intensity based on the difference between the current first magnetic flux and the initial first magnetic flux, and the difference between the current second magnetic flux and the initial second magnetic flux includes determining the current magnetic flux intensity S based on the following formula:

$$S = s q r t ( {( X 1 - X 0 )}^{2} + {( Y 1 - Y 0 )}^{2} )$$

in which X1 is the current first magnetic flux, X0 is the initial first magnetic flux, Y1 is the current second magnetic flux, and Y0 is the initial second magnetic flux.

Based on the current magnetic flux intensity S, the current wind speed V is determined based on:

$${V}^{2} = k 1 ⋆ S + b 1$$

in which k1 represents the first slope and b1 represents the first intercept, and wherein k1 and b1 are both known quantities that can be obtained through pre-testing. For example, the device can be tested under different wind speed conditions to obtain different wind speeds based on magnetic flux intensity under the conditions. Linear regression can then be performed based on these data to obtain k1 and b1. For example, after obtaining the magnetic flux intensity under different wind speed conditions, the function formula SLOPE in Excel can be used to calculate k1, and the function formula INTERCEPT in Excel can be used to calculate b1.

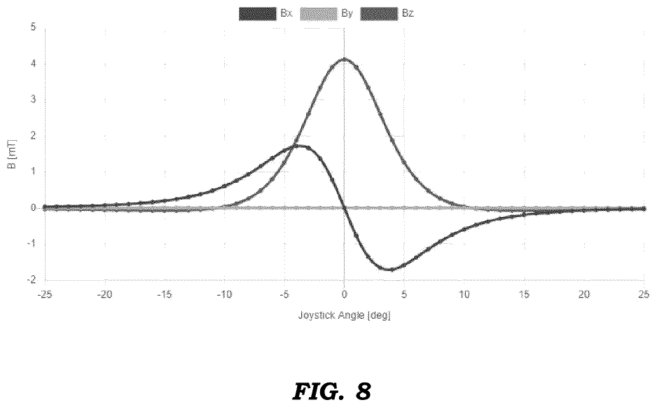

FIG. 7 shows a schematic diagram of the movement of a wind resistance ball under the action of wind force according to an embodiment of the present invention. As shown in FIG. 7, P is the wind pressure on the wind resistance ball, L is the length of the swing pin, and yb is the deflection distance of the wind resistance ball. According to the formula:

$$y = - \frac{{Px}^{2} ( 3 L - x )}{6 EI}$$

in which x=L, the maximum wind formula is:

$$yb = \frac{{PL}^{3}}{3 EI}$$

in which E is the elastic modulus of the swing pin, and the moment of inertia (I) of the swing pin section is calculated according to:

$$I = \frac{π {d}^{4}}{64}$$

where d is the cross-sectional diameter of the swing pin.

According to the wind pressure formula of Bernoulli's equation:

$$P = 0.5 ⋆ R 0 ⋆ V ⋆ V ,$$

where P is the wind pressure in kN/m2, R0 is the air density in kg/m3, and V is the wind speed in m/s.

Since the relationship between the density and weight of air is R=R0*g, it can be concluded that R0=R/g. According to the above, the wind pressure formula can be obtained from Bernoulli's equation:

$$P = 0.5 ⋆ R ⋆ V ⋆ V / g$$

in which g=9.8 m/s² and R is the air weight. Under standard conditions (air pressure 1013 hPa and temperature 15 degrees C.), R=0.01225 KN/m3.

Substituting the air weight and g under standard conditions, the standard wind pressure formula can be obtained:

$$P = V ⋆ V / 1600$$

The cross-sectional area of the wind resistance ball can be expressed as:

$$Bs = π {Br}^{2}$$

According to the pressure formula:

$$P = Bf / Bs = V ⋆ V / 1600 ⋆ 1000$$

we have:

$$Bf = Bs ⋆ V ⋆ V / 1600 ⋆ 1000 = π {Br}^{2} ⋆ V ⋆ V / 1.6 .$$

Based on the above formula, it will be apparent that the square of the wind speed is proportional to the deflection of the wind resistance ball, and the deflection is proportional to the magnetic flux intensity, at least within a short range. Therefore, there must also be a conversion relationship between the square of the wind speed and the magnetic flux intensity. That is, V2=k1*S+b1. Based on this, the wind speed may be determined based on the difference between the current first magnetic flux and the initial first magnetic flux, and the difference between the current second magnetic flux and the initial second magnetic flux. This method is simple to implement and the results are highly accurate.

In some embodiments, before determining the current magnetic flux intensity based on the difference between the current first magnetic flux and the initial first magnetic flux, and the difference between the current second magnetic flux and the initial second magnetic flux, the method further includes:
determining whether the current third magnetic flux exceeds the magnetic flux threshold;

if the current third magnetic flux exceeds the magnetic flux threshold, determining the current wind speed based on the current third magnetic flux; and
if the current third magnetic flux does not exceed the magnetic flux threshold, determining the current magnetic flux intensity based on the difference between the current first magnetic flux and the initial first magnetic flux, and the difference between the current second magnetic flux and the initial second magnetic flux.

FIG. 8 shows a schematic diagram of magnetic flux changes according to an embodiment of the present invention, wherein the horizontal axis represents the offset angle of the magnet 22, and the vertical axis represents the magnetic flux intensity. As shown in FIG. 8, when the wind resistance ball 20 deviates left and right from the stationary state (corresponding to the origin in the figure), the magnetic flux Bx in the x direction will increase, but the magnetic flux Bx will reach a peak value after deviating at a certain angle, and the magnetic flux Bx will decrease with further offset. When the magnetic flux Bx reaches the peak value and then deviates, the wind speed determined using the magnetic flux Bx may not be accurate. In view of this, the inventor considered determining the wind speed through the magnetic flux in the z direction after exceeding a certain critical point. This critical point is the magnetic flux threshold. In some embodiments, the magnetic flux in the z direction corresponding to the peak point of the magnetic flux in the x direction can be determined in advance through experiments to obtain the magnetic flux threshold. In some embodiments, determining the current wind speed based on the current third magnetic flux includes determining the current wind speed according to:

$${V}^{2} = {k}_{2} ⋆ Z + {b}_{2}$$

in which Z is the current third magnetic flux, and k2 and b2 are the second slope and the second intercept, respectively. Both k2 and b2 are known quantities and can be obtained through pre-testing. For example, the third magnetic flux under different wind speed conditions can be obtained when the third magnetic flux exceeds the magnetic flux threshold. Linear regression can then be performed based on these data to obtain k2 and b2.

In some embodiments, when the current third magnetic flux does not exceed the magnetic flux threshold, the current wind speed is determined based on the difference between the current first magnetic flux and the initial first magnetic flux, and the difference between the current second magnetic flux and the initial second magnetic flux. When the current third magnetic flux exceeds the magnetic flux threshold, the current wind speed is determined based on the current third magnetic flux. Therefore, the accuracy of the determined wind speed can be guaranteed under different wind speed conditions.

For example, obtaining the current magnetic flux of the magnet includes:
using a magnetic sensor to repeatedly detect the magnetic flux of the magnet according to a preset sampling interval within a preset time period to obtain multiple sets of magnetic flux data; and
calculating the average of the multiple sets of magnetic flux data to obtain the current magnetic flux.

It will be appreciated that the average value of multiple sets of magnetic flux data refers to the average value of magnetic flux in the same direction in multiple sets of magnetic flux data. That is, when the magnetic flux data includes magnetic flux in the three directions of x, y, and z, the average magnetic flux value in the x direction, the average magnetic flux value in the y direction, and the average magnetic flux value in the z direction of multiple sets of magnetic flux data can be calculated to obtain the current magnetic flux.

In some embodiments, both the preset sampling interval and the preset period can be selected according to actual needs. In one preferred embodiment, the preset time period may be in the range of 3-20 s, and the preset sampling interval may be in the range of 5 ms-20 ms. That is, the magnetic flux in x, y, and z directions output by the magnetic sensor is continuously read at a sampling rate of 5 ms-20 ms over a continuous sampling period of 3 s-20 s.

The above technical solution determines the current magnetic flux by integrating the results of multiple measurements, which can avoid the adverse impact of a single measurement error on the results, thereby helping to improve the accuracy of the final determined wind speed and direction.

Although example embodiments have been described herein with reference to the accompanying drawings, it should be understood that the above-described embodiments are exemplary only, and are not intended to limit the scope of the invention thereby. Various changes and modifications can be made therein by those of ordinary skill in the art without departing from the scope and spirit of the invention. All such changes and modifications are intended to be included within the scope of the invention as claimed in the appended claims.

Those of ordinary skill in the art will appreciate that the units and algorithm steps of each example described in conjunction with the embodiments disclosed herein can be implemented with electronic hardware, or a combination of computer software and electronic hardware. Whether these functions are performed in hardware or software depends on the specific application and design constraints of the technical solution. Skilled artisans may implement the described functionality using different methods for each specific application, but such implementations should not be considered to be beyond the scope of the present invention.

In the several embodiments provided by the present invention, it should be understood that the disclosed devices and methods can be implemented in other ways. For example, the device embodiments described above are only illustrative.

In the embodiments described herein, a number of specific details are described. However, it is understood that embodiments of the invention may be practiced without these specific details. In some instances, well-known methods, structures, and techniques have not been shown in detail so as not to obscure the understanding of this description.

Similarly, it should be understood that in the description of exemplary embodiments of the invention, in order to streamline the invention and aid in the understanding of one or more of the various inventive aspects, various features of the invention are sometimes grouped together into a single embodiment drawings or in its description. This method of invention is not to be interpreted, however, as reflecting an intention that the claimed invention requires more features than are expressly recited in each claim. Rather, as reflected in the corresponding claims, it is apparent that a corresponding technical problem may be solved with less than all features of a single disclosed embodiment. Thus, the claims are hereby expressly incorporated into this specification, with each claim standing on its own as a separate embodiment of this invention.

It will be understood by those skilled in the art that all features disclosed in this specification (including the accompanying claims, abstract, and drawings) and all features of any method or apparatus so disclosed may be used in any combination, except where features are mutually exclusive. Each feature disclosed in this specification (including accompanying claims, abstract, and drawings) may be replaced by alternative features serving the same, equivalent or similar purpose, unless expressly stated otherwise.

Furthermore, those skilled in the art will understand that although some embodiments described herein include certain features included in other embodiments but not others, combinations of features of different embodiments are meant to be within the scope of the invention. For example, in the claims, any of the claimed embodiments may be used in any combination.

Various component embodiments of the present invention may be implemented in hardware, or in software modules running on one or more processors, or in a combination thereof. Those skilled in the art should understand that a microprocessor or a digital signal processor (DSP) may be used in practice to implement some or all functions of some modules in the controller according to embodiments of the present invention. The invention may also be implemented as a device program (e.g., a computer program and a computer program product) for performing part or all of the methods described herein. Such a program implementing the present invention may be stored on a computer-readable medium, or may be in the form of one or more signals. Such signals may be downloaded from an Internet website, or provided on a carrier signal, or in any other form.

It should be noted that the above-mentioned embodiments illustrate rather than limit the invention, and that those skilled in the art will be able to design alternative embodiments without departing from the scope of the appended claims. In the claims, any reference signs placed between parentheses shall not be construed as limiting the claim. The word “comprising” does not exclude the presence of elements or steps not listed in a claim. The word “a” or “an” preceding an element does not exclude the presence of a plurality of such elements. The invention may be implemented by means of hardware comprising several different elements and by means of a suitably programmed computer. In a unit that enumerates several devices in accordance with the requirements, several of these devices may be embodied by the same hardware item. The use of the words first, second, third, etc. does not indicate any order. These words can be interpreted as names. The above are only specific embodiments of the present invention or explanations of specific implementations. The protection scope of the present invention is not limited thereto. Any person familiar with the technical field can easily implement the invention within the technical scope disclosed in the present invention. Any changes or substitutions that are thought of should be included in the protection scope of the present invention. The protection scope of the present invention shall be subject to the protection scope of the claims.

What is claimed is:

1. A wind direction and wind speed measuring apparatus comprising:
a cover portion;
a swing pin having an upper end and a lower end, wherein the upper end is attached to the cover portion;
a base disposed below the swing pin;
a wind resistance ball attached to the lower end of the swing pin and suspended above the base;
a magnet disposed at a bottom portion of the wind resistance ball;
a magnetic sensor disposed on the base and below the magnet, such that the magnetic sensor is operable to detect a current magnetic flux of the magnet; and
a controller in electrical communication with the magnetic sensor and operable to obtain the current magnetic flux of the magnet, and determine a current wind speed and current wind direction based at least in part on a difference between the current magnetic flux of the magnet and an initial magnetic flux of the magnet in a windless state.

2. The apparatus according to claim 1, further comprising:
an electronic compass disposed on the base, the electronic compass operable to obtain geomagnetic azimuth information,
wherein the controller is in electrical communication with the electronic compass to obtain the geomagnetic azimuth information therefrom.

3. The apparatus according to claim 1, further comprising a protective net disposed between the cover and the base, wherein the protective net is disposed around the wind resistance ball.

4. A wind direction and wind speed measurement method performed at least in part using the apparatus of claim 1, the method comprising:
determining the current magnetic flux of the magnet; and
determining the current wind speed and direction based at least in part on the difference between the current magnetic flux of the magnet and the initial magnetic flux of the magnet in a windless state.

5. The method of claim 4, wherein the initial magnetic flux includes an initial first magnetic flux, an initial second magnetic flux, and an initial third magnetic flux, and wherein determining the current magnetic flux includes:
determining a current first magnetic flux along an x-axis direction of the magnetic sensor;
determining a current second magnetic flux along a y-axis direction of the magnetic sensor; and
determining a current third magnetic flux in a z-axis direction of the magnetic sensor, and
determining the current wind speed and wind direction based at least in part on the difference between the current magnetic flux of the magnet and the initial magnetic flux of the magnet in a windless state includes:
determining the magnetic wind direction according to a first magnetic flux difference and a second magnetic flux difference, wherein the first magnetic flux difference is the difference between the current first magnetic flux and the initial first magnetic flux, and the second magnetic flux difference is the difference between the current second magnetic flux and the initial second magnetic flux; and
determining the current wind direction based at least in part on the magnetic wind direction.

6. The method of claim 5, wherein the apparatus includes an electronic compass that obtains a geomagnetic azimuth, and wherein determining the current wind direction based on the magnetic wind direction includes determining the current wind direction based on the magnetic wind direction and the geomagnetic azimuth by:
determining an actual geomagnetic azimuth angle according to a difference between the geomagnetic azimuth and a geomagnetic declination angle; and
determining the current wind direction based on the magnetic wind direction, the actual geomagnetic azimuth angle, and a deviation angle between the electronic compass and the magnetic sensor, wherein the deviation angle is an angle between a device coordinate system corresponding to the electronic compass and a device coordinate system corresponding to the magnetic sensor.

7. The method of claim 5, wherein determining the magnetic wind direction according to the first magnetic flux difference and the second magnetic flux difference includes:
determining the magnetic wind direction to be 90° when the first magnetic flux difference is greater than zero and the second magnetic flux difference is equal to zero;
determining the magnetic wind direction to be 270° when the first magnetic flux difference is less than zero and the second magnetic flux difference is equal to zero; and
determining the magnetic wind direction based on the current wind angle when the second magnetic flux difference is not zero, wherein the current wind angle is the arctangent of the ratio of the first magnetic flux difference to the second magnetic flux difference.

8. The method of claim 4, wherein
the magnetic flux includes a first magnetic flux along the x-axis direction of the magnetic sensor, a second magnetic flux along the y-axis direction of the magnetic sensor, and a third magnetic flux along the axial direction, which is the z-axis direction of the magnetic sensor,
the current magnetic flux of the magnet includes the current first magnetic flux, the current second magnetic flux, and the current third magnetic flux, and
the initial magnetic flux of the magnet in the windless state includes the initial first magnetic flux, the initial second magnetic flux, and the initial third magnetic flux, and
determining the current wind speed based on the difference between the current magnetic flux of the magnet and the magnetic flux of the magnet in a windless state includes:
determining the current magnetic flux intensity according to the difference between the current first magnetic flux and the initial first magnetic flux, and the difference between the current second magnetic flux and the initial second magnetic flux; and
determining the current wind speed based on the current magnetic flux intensity, and
wherein the method includes:
determining whether the current third magnetic flux exceeds a magnetic flux threshold;
determining the current wind speed based on the current third magnetic flux when the current third magnetic flux exceeds the magnetic flux threshold; and
when the current third magnetic flux does not exceed the magnetic flux threshold, the step of determining the current magnetic flux intensity is based on the difference between the current first magnetic flux and the initial first magnetic flux, and the difference between the current second magnetic flux and the initial second magnetic flux.

9. The method of claim 4 wherein determining the current magnetic flux of the magnet includes:
using the magnetic sensor to repeatedly detect the magnetic flux of the magnet during a preset time period to obtain multiple sets of magnetic flux data; and
calculating the average value of the multiple sets of magnetic flux data to obtain the current magnetic flux.
